(19) United States
(12) Patent Application Publication
(10) Pub. No.: US 2005/0113279 A1
(43) Pub. Date: May 26, 2005

(54) Detergent tablet comprising two layers reactive during dissolution, separated by a barrier layer

(75) Inventors: Philippe Marie Desmarescaux, Lyon (FR); Olivier Pierre Louis Marie Desmarescaux, Lyon (FR); Jean-Louis Maitre, St-Galmier (FR)

Correspondence Address: OLIFF & BERRIDGE, PLC, P.O. BOX 19928, ALEXANDRIA, VA, 22320, US

(73) Assignee: EUROTAB SA, Saint Just Saint Rambert (FR)

(21) Appl. No.: 10/718,623

(22) Filed: Nov. 24, 2003

(51) Int. Cl. C11D 17/00

(52) U.S. Cl. 510/447

(57) ABSTRACT

Detergent tablet comprising two layers reactive during dissolution, separated by a barrier layer The present invention relates to a detergent tablet consisting of at least three separate layers, two outer layers being separated by a middle layer, wherein: (i) the first outer layer comprises at least a first compound—detergent agent and/or bleaching agent—which can react chemically with at least a second compound—detergent agent and/or bleaching activator—contained in the second outer layer, and (ii) the middle layer is chemically neutral toward the compounds of the outer layers, and (iii) the compounds of the outer layers react with each other when the tablet is immersed in aqueous medium to form at least a third compound with enhanced detergent and/or bleaching properties.

The present invention relates to a universal household cleaner provided in the form of a tablet comprising at least three layers.

Some universal household cleaners contain a detergent mixture, bleaching and/or biocidal agents, a pH regulator, to which there may be added antifoaming agents, fragrances, dyes, in order to optimize the use and the presentation. The products thus obtained make it possible to carry out the cleaning of various surfaces or objects, for example hard surfaces of the following types: floors, walls, glass panes, work surfaces, surfaces of domestic appliances or of bathroom installations, and the like. These universal household cleaners, depending on the dose of their various constituents, can also serve for cleaning dishes or clothes.

In the field of universal household cleaners, the products are most often presented in liquid form, packaged in plastic bottles. It is also possible to find them in the form of solutions packaged in a spraying device or in powdered form. However, these presentation forms of the products have certain disadvantages.

Products packaged in liquid form have certain disadvantages. In the case where they are highly diluted—in general in more than 95% of water —, they occupy a large volume. Such a volume poses logistical and storage problems and the conveying of the bottles to platforms for distribution to the customer. Next, once in a shop they occupy a large space on the shelves, further increasing their cost price. Once used, there is packaging to be destroyed or recycled whose weight is high. In the case where the household cleaners are packaged in concentrated liquid form, the problem arises from their preparation before use. Indeed, the consumer has to measure out a defined and reproducible quantity of active product in a certain quantity of water, which is usually difficult to carry out.

As for the products packaged in powdered form, they also have disadvantages in that a powder is sensitive to moisture and often forms into a block during a long period of storage. Furthermore, the dissolution time for a powder is variable and its measuring out remains difficult for the consumer.

Solutions have been offered by providing universal household cleaners in the form of compact tablets, corresponding to a predetermined dose of active compounds for cleaning a given surface. The tablets are compact, and therefore use little packaging compared with the quantity of detergent product packaged. The logistics and storage in shelf spaces are therefore made less costly, and the use for the consumer is simpler since it is sufficient, in order to clean a given surface, to dissolve a tablet in a defined quantity of water. The measuring out is therefore simple and reproducible from one cleaning operation to another. In addition, the tablets are generally packaged individually, or in pairs, in individual plastic bags which make the tablets insensitive to moisture during long periods of storage, because there is no risk of their becoming hard, or on the contrary of disintegrating.

Furthermore, the tablets make it possible to optimize the efficacy of universal household cleaners by exploiting the chemical properties of certain active compounds present in the tablet, which dissolves at the time of use.

It is thus possible to have compounds which are active but by nature chemically unstable, which are created and released only at the time of use of the household cleaner. This may be a bleaching or biocidal agent, for example nascent oxygen, peroxide agents—for example hydrogen peroxide. It presupposes using, in the tablet, two compounds which react chemically at the time of dissolution of the tablet in water, to give rise to at least one new active compound.

It may also be possible to select highly performing detergent compounds which are sometimes incompatible with the other compounds of the tablet, for example nonionic or cationic surfactants which are not compatible with peracetic acid which could be generated from tetraacetylethylenediamine (TAED) used as complexing agent/builder.

To improve the chemical stability of the various constituents of the tablet, the idea arose to separate the compounds which react with each other in separated zones of the tablet, so as to prevent a premature chemical reaction during storage. Thus, documents EP 481792 A1 and EP 481793 A1 describe household cleaning tablets which comprise a bleaching agent and a bleaching activator, each located in a separate part of the tablet.

However, the tablets described above still have certain disadvantages. Indeed, it has appeared that despite the separation of the compounds which react or are incompatible with each other in adjacent separate layers of the tablet, degradations can occur. Indeed, it has appeared that migrations of compounds are possible during storage of the tablets, even though the tablets are protected from ambient moisture by a barrier film. The result of this migration is a degradation of certain compounds by chemical reactions, and a loss of cleaning power of the tablet.

To respond to the disadvantages mentioned above and to provide optimizations of the household cleaner as a tablet, the claimed tablet according to the invention is based on a structure comprising at least three layers.

A middle layer makes it possible to separate the outer layers with products which are chemically inert compared with the constituents of these two outer layers; preferably, it also contains an effervescent or disintegrating system, or a burst system, allowing controlled and accelerated dissolution of the tablet in the presence of water.

The outer layers make it possible to obtain a given product, according to the chemical reactivity of the compounds which they contain respectively. For example, the bleaching/biocidal system will be obtained by confining a persalt (perborate, percarbonate) in one of the two layers and an acid (citric acid, and the like) in the other outer layer.

Advantageously, the middle layer comprises an effervescent system which will make it possible to increase the dissolution and the mixing of the compounds of the two outer layers at the time of use.

The outer layers comprise detergent systems, preferably combined with bleaching agents.

Advantageously, the outer layers, separated by the middle layer which is chemically neutral toward these two outer layers, contain complexing agents—or “builders”—which are incompatible with each other.

The invention will now be described in greater detail, in particular its chemical constituents. This description will be complemented by examples of compositions and structures of multilayer detergent tablets according to the invention, given by way of nonlimiting examples.

The present invention relates to a household detergent tablet of the so-called “universal” type, that is to say which may be suitable for several different household tasks. These household tasks include, by way of nonlimiting examples, the cleaning of hard surfaces such as floors or work surfaces, or the cleaning of dishes. It is also possible to envisage cleaning clothes, according to the compounds used in the tablet, and their concentration.

The detergent tablet according to the invention consists of at least three separate layers, two outer layers being separated by a middle layer, and:
(i) the first outer layer comprises at least a first compound—detergent agent and/or bleaching agent—which can react chemically with at least a second compound—detergent agent and/or bleaching activator—contained in the second outer layer,
(ii) the middle layer is chemically neutral toward the compounds of the outer layers, and
(iii) the compounds of the outer layers react with each other when the tablet is immersed in aqueous medium to form at least a third compound with enhanced detergent and/or bleaching properties.

The expression compound with “enhanced” detergent and/or bleaching properties is understood to mean a new compound created directly in the washing water at the time of dissolution, which consequently has a particularly effective detergent action because of its chemical nature, and because this compound is created and acts in situ. The term “enhanced detergent and/or bleaching properties” is not used here in a limiting manner, the enhanced properties may relate to any property of the new compound capable of improving the washing efficacy.

The middle layer therefore makes it possible to separate the outer layers with products which are inert in relation to the constituents of these two outer layers, that is to say that it plays the role of a physicochemical barrier. Preferably, it also contains an effervescent or disintegrating system allowing controlled and accelerated dissolution of the tablet in the presence of water and making it possible to increase the dissolution and the mixing of the compounds of the two outer layers at the time of use.

The middle layer may also comprise at least one bursting agent. Bursting agents are compounds with a practically immediate disintegration action upon contact with an aqueous medium. They allow an even quicker dissociation of the two outer layers of the tablet than during the use of effervescent agents.

Whether with the aid of effervescent or bursting agents, the middle layer is preferably completely dissolved before the outer layers. Thus, in particular when bursting agents are used, the middle layer disappears after a few seconds after the tablet has been immersed in water, such that the outer layers are dissociated. The surface of contact with the washing water is thus doubled and their dissolution is quicker. Likewise, the chemical reaction of at least some of their constituents in order to create a new compound with enhanced detergent and/or bleaching agent is accelerated.

The outer layers make it possible to obtain a given product according to the chemical reactivity of the compounds which they respectively contain. For example, a bleaching/biocidal system may be obtained by confining a persalt (perborate, percarbonate) in one of the two layers and an acid (citric acid and the like) in the other outer layer.

The outer layers comprise detergent systems, preferably combined with bleaching agents.

Advantageously, the tablet may contain complexing agents—or “builders”—, usually chemically incompatible with each other, which are, according to the invention, distributed in the nonadjacent outer layers, because they are separated by a neutral middle layer (that is to say which is chemically inert toward the compounds of these outer layers).

Packaging of the Tablets

The packaging of the detergent tablets according to the invention is carried out by wrapping the tablets individually or in groups, preferably in pairs, in plastic bags. The packaging is carried out by known techniques for automated packaging in bags, for example “Form/Fill/Seal”. The bags are made of heat-sealable plastic films having moisture-barrier properties. This makes it possible to avoid the tablets disintegrating or on the contrary becoming hard by absorbing water contained in the air during their storage.

Composition

The detergent tablet according to the invention preferably comprises a mixture of the following systems of compounds:
a binary, or preferably ternary, surfactant system based on a mixture of surfactants: anionic and nonionic, or anionic, and soaps: nonionic, or cationic and nonionic, or nonionic and nonionic;
a bleaching system based on the following mixtures, given by way of nonlimiting examples: 1) perborate and/or percarbonate optionally coupled with a bleaching activator, 2) halogenated derivatives of the dichloroisocyanurate type;
a complexing system comprising, alone or as a mixture, the following types of compounds: phosphates, citrates, complexing polymers, phosphonates, polysuccinimide derivatives;
an effervescent system comprising the mixture of an organic acid and an organic base of the bicarbonate or carbonate type;
a pH regulator comprising, alone or as a mixture, the following types of compounds: carbonate, bicarbonate, sesquicarbonate, disilicate of sodium or potassium, borate, citric, adipic, maleic, malic or tartaric acids;
additives comprising fragrances, dyes, pelleting aids and aids for forming the tablets during their manufacture, and optionally antibacterial agents.

The distribution of the various systems of compounds cited above in the tablet is carried out according to the chemical compatibility of the compounds used (of which a nonexhaustive list is provided below, for each system). It is thus possible to find identical or similar detergent and/or bleaching compounds in each of the outer layers of the tablet, or even possibly in the middle layer.

Nevertheless, care will be taken not to mix, in the same layer, incompatible or chemically reactive compounds. Indeed, this would cause the risk of seeing the development, during storage, of the phenomena of degradation of certain compounds, or the appearance of new active detergent compounds whose stability, and therefore whose lifetime, is short and which it is desired to cause to appear only at the time of the cleaning operation.

First of all, in the tablet according to the invention, the bleaching agent, for example DCCNa (dichloroisocyanurate), are preferably placed in an outer layer not adjacent to that in which nonionic surfactant compounds and fragrances, which are usually very reactive with DCCNa, are placed in order to avoid their interaction which would have as a consequence a loss of hypochlorite and denaturation of the nonionic surfactant and of the fragrance. Another example is the case of a tablet containing percarbonate (another bleaching agent) in a first outer layer, and the nonionic surfactant and the fragrance in another outer layer, both outer layers being, according to the invention, separated by an inert middle layer in order to avoid interaction between the bleaching agent, on the one hand, and the nonionic surfactant and the fragrance, on the other hand, which would have as a consequence a loss of oxygen and impairment of the surfactant and of the fragrance.

Secondly, in the tablet according to the invention, certain compounds which should react only at the time of dissolution of the tablet will be separated in nonadjacent separate layers of the tablet. That is in particular the case for the bleaching agents and the bleaching activators which will each be separated in a separate outer layer of the tablet. Thus, a percarbonate or a perborate will be separated for example from TAED.

To provide the desired washing efficacy as well as a rapid use and a capacity for the manufacture of tablets, the product should correspond to the expected criteria in relation to the choice of the various ingredients and their percentage. The different compounds corresponding to the systems cited above will now be described in detail. In all cases, they will have to be placed in a layer of the tablet according to their reactivity toward the other constituents of said layer.

Surfactants

The detergent composition generally comprises a mixture of nonionic surfactants, alone or in combination with other surfactants of the anionic and/or cationic and/or amphoteric and/or semipolar type.

The percentage of surfactants in the formula is of the order of 0.1 to 30%, preferably 0.1 to 10%.

The various surfactant compounds which may be incorporated into the tablet, alone or as a combination, are described below by category.

Nonionic Surfactants:

This may be polyethylene oxide, polypropylene oxide, polybutylene oxide condensed with:
alkylphenols: it being possible for the alkyl chain to be straight or branched. The alkyl group containing from 6 to 14 carbon atoms, preferably from 8 to 14 carbon atoms, the number of ethylene oxides being from 2 to 50, preferably from 4 to 50;
primary or secondary alcohols, it being possible for the alkyl chain to be straight or branched and containing from 8 to 22 carbon atoms;
alkyl polysaccharides with a hydrophobic group containing from 6 to 30 carbon atoms, preferably from 10 to 16 carbon atoms and a polysaccharide (polyglycoside) in which the hydrophilic group contains 1.3 to 3 sucrose units,
products of condensation of ethylene oxide with a hydrophobic base formed by condensation of propylene oxide with propylene glycol,
fatty polyhydroxyamides,
ethoxylated triglycerides,
ethoxylated methyl esters.
   Anionic Surfactants:

They are selected from the list given below without limitation, knowing that the alkyl chain preferred for cleanings at a temperature of less than 50° C. is C12 and C16:
linear alkylbenzene sulfonates (C8 to C15 alkyl chain);
alkyl sulfates (C8 and C24 alkyl chain);
anionic surfactants in which the neutralizing cation is sodium, potassium or lithium.

The other anionic surfactants which can be used comprise: soap, C8 and C22 alkanesulfonates for primary or secondary surfactants, C8 and C24 olefinsulfonates, alkyl polyglycol ether sulfate (EO content of 0.1 to 10 EO), alkylglyceryl sulfate, ethoxylated alkylphenol ether sulfates, alkyl succinamates or sulfosuccinates, branched alkyl sulfates, alkyl polyethoxycarboxylates.

In all cases, the neutralizing cation is a sodium, potassium or lithium ion.

Cationic Surfactants:

The cationic surfactants have a long hydrocarbyl group chain, are soluble in water and have a general formula of the type:
R1-R2-R3-R4-N+ X−
R1 is a C8-C18 alkyl chain
R2, R3, R4 are independent chains as C1-C4 alkyl,
C1-C4 hydroxyalkyl, benzyl and (C2 H40) XH with X which has the value 2 to 5—and X is an anion.

“Builder” System

The “builder” systems which may be used in the context of the invention are contained in the list of:
phosphates (orthophosphate, pyrophosphate, tripolyphosphate, hexametaphosphate, sodium or potassium salt, anhydrous, prehydrated or hydrated),
NTA, EDTA, DTPA type complexing agents;
phosphonates;
hydrated Zeolite type ion exchangers of the A-X, B—HS or MAP type;
lamellar silicates of the SKS-6 type;
polycarboxylates with a carboxyl group or several, such as citrate, succinate, acetate of sodium or potassium;
carbonates or bicarbonates (sodium, potassium or lithium);
sodium sesquicarbonates;
amorphous and crystalline silicates;
acidic homopolymers or their sodium salt of acrylic acid;
acrylic maleic copolymers;
acrylic phosphonic or phosphinic copolymers;
polysuccinic acid derivatives.

Bleaching Agents

The bleaching agents which may be used in the context of the invention comprise:
sodium perborate mono- and tetrahydrate;
sodium carbonate peroxyhydrate;
magnesium monoperisophthalate xH₂O;
magnesium salts of chlorobenzoic acid and 4-nonylamino-4-oxoperoxybutyric acid;
potassium monopersulfate.

Another category of bleaching agent is the branch of halogen bleaching agents which comprise:
trichloroisocyanuric acid;
hydrated or anhydrous sodium or potassium salts of dichloroisocyanurates.

Enzymes

The enzymes which may be used in the context of the invention may be selected from the following list given by nonlimiting example:
proteases;
amylases;
lipases;
cellulases.

These enzymes will be optionally added to the tablet composition, in proportions well known to a person skilled in the art, for example in proportions of 0.1% to 3.0% by weight of the composition of a tablet.

Pelleting Aids

The detergent tablets according to the invention preferably additionally comprise a number of compounds which make it possible to improve the tablet-forming operation during manufacture, also called pelleting operation. In the context of the invention, these compounds will be contained in the following, nonlimiting list: polyethylene glycol (MW 1500 to 20 000); Ca or Mg stearate; bentonite type clay; crystalline celluloses; derivatives of cellulose or of starch; triglycerides of plant or animal origin; sugar derivatives; and the like.

Disintegrating Agents or Agents for Quick use of the Tablet

According to a preferred embodiment of the invention, the middle layer which makes it possible to produce a barrier between the reactive outer layers, contains an effervescent system, and/or a system with bursting action, allowing quick disintegration—or use—of the tablet when it is immersed in water during use.

Advantageously, the outer layers may also comprise effervescent agents or bursting agents.

The effervescent agents may comprise mixtures of organic or inorganic acids with carbonates and/or bicarbonates.

The bursting agents may comprise: amorphous or crystalline celluloses; crosslinked acrylic polymers; modified polyvinylpyrrolidones; clays with high swelling power; sodium acetates, and the like.

Finally, the detergent tablet according to the invention may comprise other compounds or additives such as fragrances, dyes or antifoams.

Manufacture

The detergent tablet according to the invention may be manufactured according to known pelleting processes. These processes generally include the following stages:
preparation of the detergent mixtures corresponding to the various layers of the tablet in Nautamix, Lazareth, Forberg and Lodige type mixers;
conveying of each layer of the tablet into a mold of the pelletizer by a separate feed;
application of a compression force on the layers of the tablet contained in the mold by means of a die. It is then possible to modify the precompression and compression forces applied to each layer, by varying the force applied by the die of the pelletizer inside the mold. It is thus possible to adjust the hardness of the tablet, and therefore its dissolution time.

Advantages

The universal household cleaner in the form of a multilayer tablet according to the invention has many advantages. It makes it possible to optimize the logistics of manufacture, storage and transport and makes it possible to reduce congestion in the shelf spaces in a shop. Indeed, the detergent formula is highly concentrated since it represents a dose of active products of 0.5 g to 2 g in a tablet having a weight of between 2 and 10 g, preferably between 5 and 10 g, for a cleaning product volume, once diluted, having a volume of between 500 ml and 10 liters of water. In addition, its use is quick and its dissolution time is less than 5 min, preferably less than 90 seconds, or even less than 60 seconds.

### EXAMPLES OF DETERGENT FORMULA ACCORDING TO THE INVENTION

### Example 1

A first example of composition of a detergent tablet according to the invention is given below, which also mentions the product formed after reaction of the compounds of the two outer layers during dissolution.

1^{st} layer (outer):

| | |
|---|---|
| percarbonate | 20 |
| citric acid | 10.00 |
| alkylsulfate | 5 |
| bicarbonate | 5.00 |
| Total: | 40.00 |

2^{nd} layer (middle):

| | |
|---|---|
| bicarbonate | 9.5 |
| PEG | 1 |
| adipic acid | 9.5 |
| Total: | 20.00 |

3^{rd} layer (outer):

| | |
|---|---|
| TAED | 12.5 |
| bicarbonate | 11.1 |
| citric acid | 10.00 |
| nonionic | 3.00 |
| fragrance | 1.5 |
| precipitated silica | 1.9 |
| Total: | 40.00 |

A new detergent compound is obtained after dissolving the tablet in a variable volume of water, for example from 5 to 10 liters of water, by reaction of the compounds of the two outer layers. More particularly, upon use, the percarbonate contained in the first layer dissolves and releases hydrogen peroxide. The TAED contained in the third layer also dissolves and combines with the hydrogen peroxide to give peracetic acid having biocidal and oxidizing properties, that is to say an active detergent agent is obtained which was not initially present in the detergent tablet.

### Example 2

A second example of composition of a detergent tablet according to the invention is given below, which also mentions the product formed after reaction of the compounds of the two outer layers during dissolution.

1^{st} layer (outer):

| | |
|---|---|
| potassium monopersulfate | 20 |
| clay | 2.50 |
| PEG 4000 | 2.50 |
| sodium alkylbenzenesulfonate | 5.00 |
| sodium carbonate | 5.00 |
| sodium bicarbonate | 5.00 |
| Total: | 40.00 |

2^{nd} layer (middle):

| | |
|---|---|
| bicarbonate | 9.5 |
| PEG | 1 |
| adipic acid | 9.5 |
| Total: | 20.00 |

3^{rd} layer (outer):

| | |
|---|---|
| sodium chloride | 10.00 |
| sodium bicarbonate | 11.10 |
| citric acid | 10.00 |
| nonionic | 3.00 |
| fragrance | 1.5 |
| precipitated silica | 1.9 |
| Total: | 40.00 |

In this formula, potassium monopersulfate contained in the first outer layer and sodium chloride contained in the second outer layer, exposed to an aqueous medium (or more simply moisture), react to form hypochlorite, a product which would have been undesirable during the preservation of the product. According to the invention, the hypochlorite formed only at the time when the tablet is immersed in water and makes it possible to improve the washing properties of the composition. Indeed, the hypochlorite demonstrates disinfectant properties and bleaching properties (attacks oxidizable stains—teas, coffees, tanins and the like).

1. A detergent tablet consisting of at least three separate layers, two outer layers being separated by a middle layer, wherein:
the first outer layer comprises at least a first compound—detergent agent and/or bleaching agent—which can react chemically with at least a second compound—detergent agent and/or bleaching activator—contained in the second outer layer, and
the middle layer is chemically neutral toward the compounds of the outer layers, and
the reactive compounds of the outer layers react with each other when the tablet is immersed in aqueous medium to form at least a third compound with enhanced detergent and/or bleaching properties.

2. The detergent tablet as claimed in claim 1, wherein the middle layer comprises at least one effervescent agent, and/or at least one bursting agent, such that when the tablet is immersed in an aqueous medium, said middle layer is completely dissolved before the outer layers.

3. The tablet as claimed in claim 1, wherein the outer layers comprise at least one effervescent agent.

4. The tablet as claimed in claim 1, which comprises at least one of the following compounds: a binary or ternary surfactant system, a bleaching system with a persalt and an activator, a complexing system, an effervescent system, a pH regulator, additives selected from fragrances, dyes, pelleting aids, antibacterial agents, or a combination of these compounds.

5. The tablet as claimed in claim 4, wherein the bleaching agents, on the one hand, and the nonionic surfactants and fragrances, on the other hand, are confined to separate and nonadjacent outer layers, separated by a middle layer which is chemically inert toward the compounds of the two outer layers.

6. The tablet as claimed in claim 1, wherein the percentage of surfactants by weight of tablet is of the order of 0.1 to 30%, preferably 0.1 to 10%.

7. The tablet as claimed in claim 1, wherein the first outer layer comprises at least one persalt, perborate or percarbonate, the second outer layer comprises at least one bleaching activator of the citric acid type, and the third compound with detergents and/or bleaching properties is an activated bleaching agent obtained by reaction of the persalt with the bleaching activator during dissolution of the tablet.

8. The tablet as claimed in claim 2, wherein the outer layers comprise at least one effervescent agent.

9. The tablet as claimed in claim 2, which comprises at least one of the following compounds: a binary or ternary surfactant system, a bleaching system with a persalt and an activator, a complexing system, an effervescent system, a pH regulator, additives selected from fragrances, dyes, pelleting aids, antibacterial agents, or a combination of these compounds.

10. The tablet as claimed in claim 3, which comprises at least one of the following compounds: a binary or ternary surfactant system, a bleaching system with a persalt and an activator, a complexing system, an effervescent system, a pH regulator, additives selected from fragrances, dyes, pelleting aids, antibacterial agents, or a combination of these compounds.

11. The tablet as claimed in 2, wherein the percentage of surfactants by weight of tablet is of the order of 0.1 to 30%, preferably 0.1 to 10%.

12. The tablet as claimed in 3, wherein the percentage of surfactants by weight of tablet is of the order of 0.1 to 30%, preferably 0.1 to 10%.

13. The tablet as claimed in 4, wherein the percentage of surfactants by weight of tablet is of the order of 0.1 to 30%, preferably 0.1 to 10%.

14. The tablet as claimed in 5, wherein the percentage of surfactants by weight of tablet is of the order of 0.1 to 30%, preferably 0.1 to 10%.

15. The tablet as claimed in claim 2, wherein the first outer layer comprises at least one persalt, perborate or percarbonate, the second outer layer comprises at least one bleaching activator of the citric acid type, and the third compound with detergents and/or bleaching properties is an activated bleaching agent obtained by reaction of the persalt with the bleaching activator during dissolution of the tablet.

16. The tablet as claimed in claim 3, wherein the first outer layer comprises at least one persalt, perborate or percarbonate, the second outer layer comprises at least one bleaching activator of the citric acid type, and the third compound with detergents and/or bleaching properties is an activated bleaching agent obtained by reaction of the persalt with the bleaching activator during dissolution of the tablet.

17. The tablet as claimed in claim 4, wherein the first outer layer comprises at least one persalt, perborate or percarbonate, the second outer layer comprises at least one bleaching activator of the citric acid type, and the third compound with detergents and/or bleaching properties is an activated bleaching agent obtained by reaction of the persalt with the bleaching activator during dissolution of the tablet.

18. The tablet as claimed in claim 5, wherein the first outer layer comprises at least one persalt, perborate or percarbonate, the second outer layer comprises at least one bleaching activator of the citric acid type, and the third compound with detergents and/or bleaching properties is an activated bleaching agent obtained by reaction of the persalt with the bleaching activator during dissolution of the tablet.

19. The tablet as claimed in claim 6, wherein the first outer layer comprises at least one persalt, perborate or percarbonate, the second outer layer comprises at least one bleaching activator of the citric acid type, and the third compound with detergents and/or bleaching properties is an activated bleaching agent obtained by reaction of the persalt with the bleaching activator during dissolution of the tablet.
